(19) United States
(12) Patent Application Publication
(10) Pub. No.: US 2009/0029333 A1
(43) Pub. Date: Jan. 29, 2009

(54) BODY PART MODEL WITH PULLOUT TABS

(75) Inventor: Ray N. Paslawski, Wildwood, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: POSITIVE OUTCOMES, INC., Wildwood, MO (US)

(21) Appl. No.: 11/781,783

(22) Filed: Jul. 23, 2007

(51) Int. Cl. G09B 23/30

(52) U.S. Cl. 434/267

(57) ABSTRACT

A body part model for a model body part of a human or other animal. The model includes a pullout tab. A base portion has one or more slots therein to accept the pullout tab with the pullout tab having a major surface thereon to display indicia that relate to the model body part.

### FIELD OF THE INVENTION

The invention relates to devices for displaying body part models. More specifically, the invention relates to an improved stand for a body part model having pullout tabs.

### BACKGROUND OF THE INVENTION

In the United States, within the last ten years, pharmaceutical companies have been allowed to advertise their products directly to patients with certain restrictions. This has created a need for advertising tools that pharmaceutical companies can use to advertise their unique products and are also tailored to comply with the specific rules for advertising pharmaceuticals.

Specifically, one type of advertising tool is a display of a human body part that a pharmaceutical or a therapeutic device company's products are designed to treat. The displays are then handed out to potential customers with information about the product being sold. These displays are difficult to compactly and efficiently produce with enough space for the advertising or regulatory information to be printed. Therefore, there is a need in the art for a body part model that can be efficiently and compactly produced while still having sufficient space on which to print regulatory and advertising information.

### SUMMARY OF THE INVENTION

The present invention comprises a body part model. The model body part is of a human or other animal body part. A base portion has one or more slots therein to accept a plurality of pullout tabs. The pullout tabs have a major surface thereon to display indicia that relate to the model body part.

### BRIEF DESCRIPTION OF THE DRAWINGS

FIG. 1 is a perspective view of a body part model according to an embodiment of the present invention;

FIG. 2 is a front view of a body part model according to an embodiment of the present invention;

FIG. 3 is a sectional view taken along line A-A of FIG. 2;

FIG. 4 is a plan view of a pullout tab according to an embodiment of the present invention;

FIG. 5 is a perspective view of a body part model according to an embodiment of the present invention having the tabs pulled outwardly; and

FIG. 6 is a right side view of a body part model according to an embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

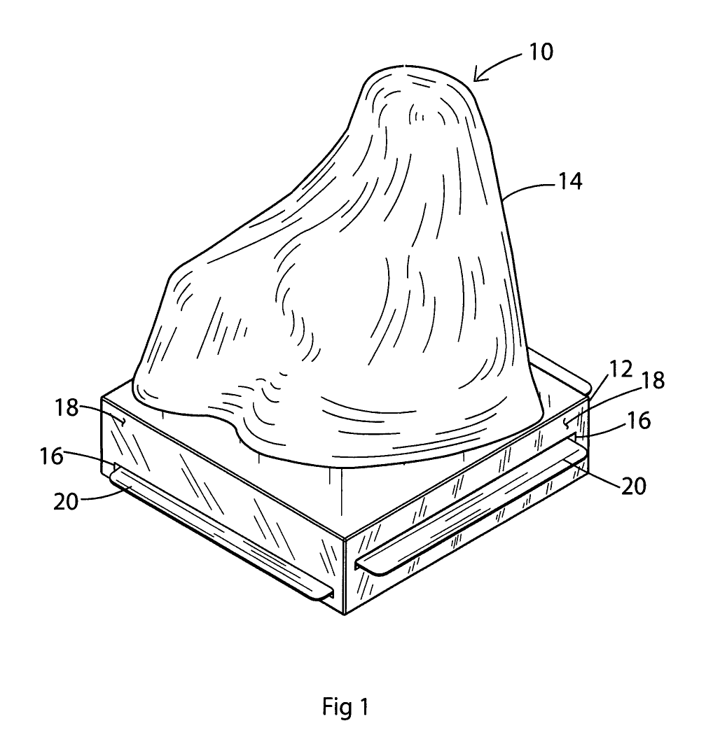

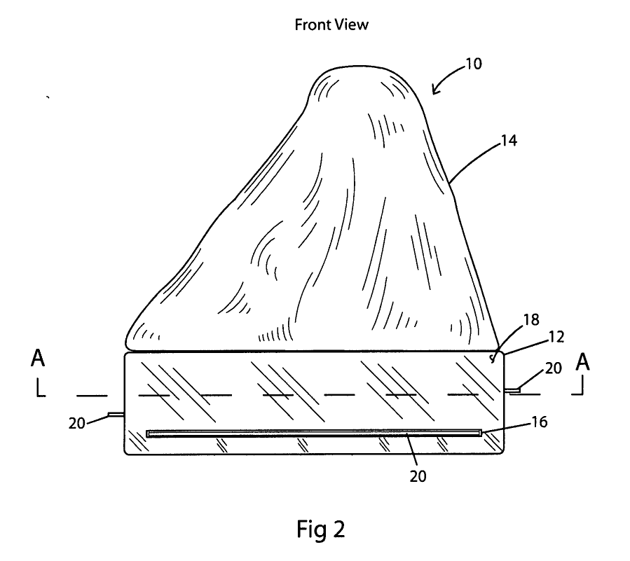

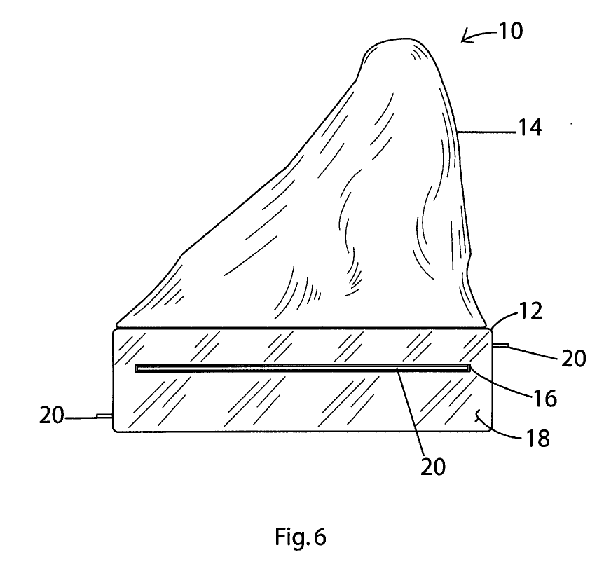

Referring to FIGS. 1, 2 and 6, there is shown and described a body part model 10 having a base portion 12 and body part portion 14. The base portion 12 is preferably made from ABS plastic. As shown in FIG. 1, the body part portion 14 represents a quantity of human fat and is preferably made from a BTER material. It is envisioned that the body portion could comprise any human body part or animal body part and is shown isolated from the body of the human or other animal. For example, a model of a heart, brain or lungs of a human or other animal could be mounted on the base portion 12.

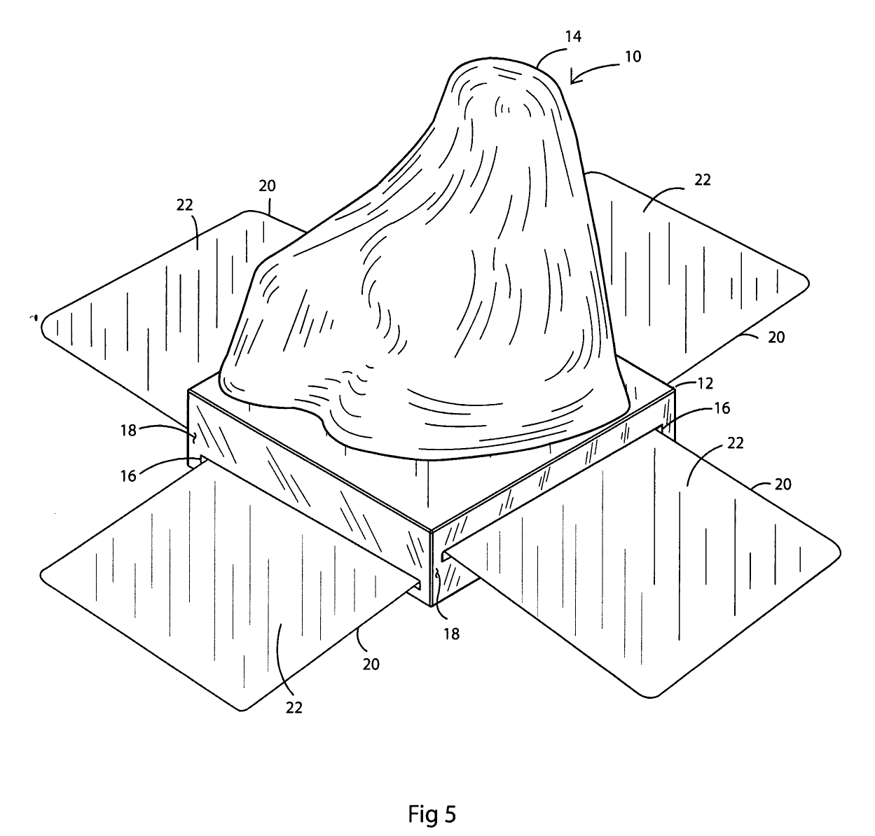

The base portion 12 further includes a plurality of slots 16 in the various side faces 18 thereof. Each slot 16 in each side face 18 is placed at a different elevation within the base portion 12 such that each slot will not intersect another slot, although it is envisioned that a single slot having multiple openings may be implemented without departing from the scope of the present invention. Pullout tabs 20 are moveable within the slots 16 to extend outwardly from the base portion 12 (FIG. 5) to expose an upper face 22 of the pullout tabs 20. The upper face 22 may be used to provide advertising or regulatory information regarding the product to be marketed. A single slot embodiment would need a slot of sufficient height in order to accept multiple pullout tabs.

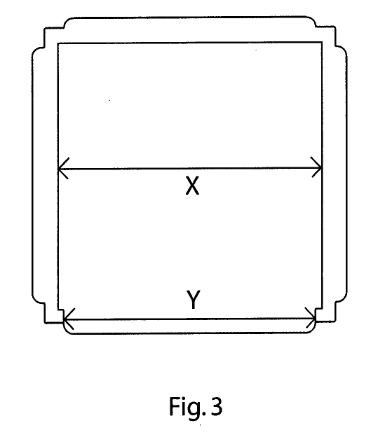

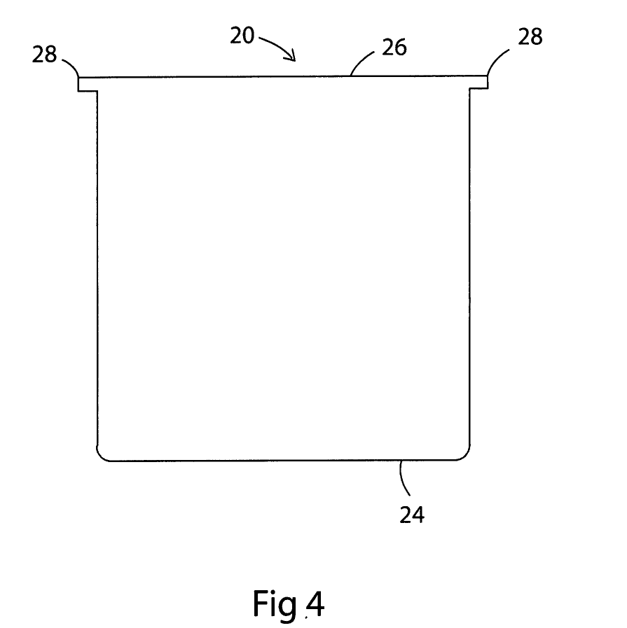

As shown in FIG. 3, the slots are of a width X and have an opening having a width Y, which is smaller than the width X. In FIG. 4, the pullout tabs 20 include a first side 24 that may be pulled by the user and a second side 26 that remains within the base portion 12. The second side 26 includes two extensions 28 that extend outwardly along the second side 26. When the pullout tab 20 is installed in the slot 20, the extensions 28 fit within the width X, but are wider than the width Y. In a preferred embodiment, the pullout tabs are installed within the base portion as the base portion is molded or assembled.

Alternatively, the pullout tab 20 could be installed within the slot 16 by resiliently deflecting the extensions 28 In this manner, the tab 20 is not easily removed or disassociated from the slot 16. In effect, the extensions 28 are resilient enough that they will flex to allow their initial installation into the slot 16 past the width Y. Once installed past the narrower width Y, the extensions 28 return to their outwardly extending shape shown in FIG. 4 and retain the tab 20 within the slot 16. Once within the slot 16, the extensions 28 may be made of a material that either allows the them to be resilient enough that they will flex to allow their initial installation into the slot 16 past the width Y or of a material that cannot be redeflected to remove them from the slot 16.

The above examples show that the invention, as defined by the claims, has far ranging application and should not be limited merely to the embodiments shown and described in detail. Instead the invention should be limited only to the explicit words of the claims, and the claims should not be arbitrarily limited to embodiments shown in the specification. The scope of protection is only limited by the scope of the accompanying claims, and the Examiner should examine the claims on that basis.

I claim:

1. A body part model comprising:
a model body part of a human or other animal;
at least one pullout tab; and
a base portion having one or more slots therein, each accepting a pullout tab, the pullout tab having a major surface thereon to display indicia that relate to the model body part.

2. The body part model of claim 1 wherein the at least one pullout tab comprises a plurality of pullout tabs and the one or more slots comprises a corresponding number of slots.

3. The body part model of claim 1 wherein the base portion comprises a generally rectangular box.

4. The body part model of claim 1 wherein the model body part is the body part of a human.

5. The body part model of claim 1 wherein the model body part is a model of a quantity of human fat.

6. The body part of claim 2 wherein the pullout tabs comprise extensions and the one or more slots comprise narrowed openings wherein the extensions are adapted to contact the narrowed openings to keep the tabs from becoming disassociated from the base portion.

7. The body part model of claim 1 wherein the plurality of slots are disposed at different elevations within the base portion to avoid their intersection within the base portion.

8. A body part model comprising:
a model body part of a human or other animal;
a plurality of pullout tabs; and
a base portion having a plurality of slots disposed at different elevations within the base portion to avoid intersection of the slots, each of the slots accepting a corresponding pullout tab, the pullout tabs having a major surface thereon to display indicia that relate to the model body part.

9. The body part model of claim 8 wherein the base portion comprises a generally rectangular box.

10. The body part model of claim 8 wherein the model body part is the body part of a human.

11. The body part model of claim 8 wherein the model body part is a model of a quantity of human fat.

12. The body part of claim 8 wherein the pullout tabs comprise extensions and the one or more slots comprise narrowed openings wherein the extensions are adapted to contact the narrowed openings to keep the tabs from becoming disassociated from the base portion.

13. A fat model comprising:
a model of a quantity of human fat;
a plurality of pullout tabs; and
a base portion comprising a generally rectangular box having a plurality of slots disposed at different elevations within the base portion to avoid intersection of the slots, each of the slots accepting a corresponding pullout tab, the pullout tabs having a major surface thereon to display indicia that relate to the quantity of fat; and
wherein the pullout tabs comprise extensions and the one or more slots comprise narrowed openings wherein the extensions are adapted to contact the narrowed openings to keep the tabs from becoming disassociated from the base portion.
